(19) United States
(12) Patent Application Publication
(10) Pub. No.: US 2025/0054676 A1
(43) Pub. Date: Feb. 13, 2025

(54) COIL DEVICE

(71) Applicant: TDK Corporation, Tokyo (JP)

(72) Inventors: Masayuki NAGATA, Tokyo (JP); Toshiyuki HORIKAWA, Tokyo (JP); Masaaki IWAKURA, Tokyo (JP); Tomohiro FURUICHI, Tokyo (JP); Kaito TANIZAKI, Tokyo (JP)

(73) Assignee: TDK Corporation, Tokyo (JP)

(21) Appl. No.: 18/794,672

(22) Filed: Aug. 5, 2024

(30) Foreign Application Priority Data
Aug. 10, 2023 (JP) 2023-131084

(51) Int. Cl. H01F 27/22; H01F 27/08; H01F 27/26; H01F 27/28; H01F 27/32

(52) U.S. Cl. CPC H01F 27/22; H01F 27/085; H01F 27/266; H01F 27/2895; H01F 27/325

(57) ABSTRACT

A coil device includes a core containing a magnetic material and a wire disposed in a coil shape around at least a part of the core. The core includes a middle leg portion and a first base portion. The middle leg portion has a winding portion of the wire disposed therearound. The first base portion is disposed apart by a predetermined distance from one end of the middle leg portion along a winding axis of the winding portion. 70% or more, preferably 80% or more, more preferably 90% or more, or still more preferably 95% or more of a volume of the middle leg portion is located below a venting surface of a heat-dissipating resin.

### TECHNICAL FIELD

The present invention relates to a coil device that can be suitably used as, for example, a transformer.

### BACKGROUND

To improve heat resistance of a coil device, its core is partly immersed in a heat-dissipating resin for enhanced cooling effects as in, for example, Patent Document 1. Unfortunately, because not much of the core is covered with the heat-dissipating resin in this technique, sufficient heat dissipation effects cannot be expected.

In this regard, a large portion of the core may be covered with the heat-dissipating resin; however, in such a structure, a case storing the heat-dissipating resin has too large a size, contrary to requests for reduction in size of the coil device. In this respect, the case storing the heat-dissipating resin may be reduced in size so that a winding portion of a wire is immersed in the heat-dissipating resin to the minimum extent necessary. In this situation, a part of the core (e.g., an upper part of the core along a winding axis of the wire) may be exposed outside the heat-dissipating resin.

In such a situation, the core turns out to have a portion that is cooled by the heat-dissipating resin and a portion that is not cooled by the heat-dissipating resin; and thermal stress may be generated at the core, significantly reducing durability of the core. In particular, along with an increase in currents of the coil device in recent years, reduction of thermal stress generated at the core has been a challenge.

Even if no portion of the core is exposed from the heat-dissipating resin, provided that there is a large difference in cooling temperature of the heat-dissipating resin along the winding axis of the wire, excessive thermal stress may be generated at the core. In this situation as well, durability of the core is reduced.
Patent Document 1: JP Patent Application Laid Open No. 2014-36194

### SUMMARY

The present invention has been achieved in view of such circumstances. It is an object of the invention to provide a coil device capable of having reduced thermal stress generated at a core.

To achieve the above object, a coil device according to the present invention is a coil device including:
a core including a magnetic material; and
a wire disposed in a coil shape around at least a part of the core,
wherein
the core includes a middle leg portion and a first base portion;
the middle leg portion has a winding portion of the wire disposed therearound;
the first base portion is disposed apart by a predetermined distance from one end of the middle leg portion along a winding axis of the winding portion; and
70% or more, preferably 80% or more, more preferably 90% or more, or still more preferably 95% or more of a volume of the middle leg portion is located below a venting surface of a heat-dissipating resin.

In this coil device, because most of the volume of the middle leg portion is located below the venting surface of the heat-dissipating resin, most of the volume of the winding portion, disposed around the middle leg portion, of the wire as well as the middle leg portion is cooled by the heat-dissipating resin. This improves heat-dissipating ability. Moreover, because the first base portion is disposed apart by the predetermined distance from the one end of the middle leg portion along the winding axis of the winding portion, stress (e.g., thermal expansion force) generated at the middle leg portion is not transferred to the first base portion even if the first base portion is partly exposed from the heat-dissipating resin. Thus, excessive thermal stress that may be generated at the first base portion can be reduced.

30% or more, 50% or more, 80% or more, or 95% or more of a volume of the first base portion may be exposed from the heat-dissipating resin. With a large portion of the first base portion being exposed, a case accommodating the heat-dissipating resin can be reduced in size, and the amount of the heat-dissipating resin can be reduced. Moreover, in this situation as well, because the first base portion is disposed apart by the predetermined distance from the one end of the middle leg portion along the winding axis of the winding portion, stress (e.g., thermal expansion force) generated at the middle leg portion is not transferred to the first base portion. Thus, excessive thermal stress that may be generated at the first base portion can be reduced.

The core may further include a second base portion provided continuously at an other end of the middle leg portion along the winding axis. Alternatively, the core may further include a second base portion disposed apart by a predetermined distance from the other end of the middle leg portion along the winding axis.

The second base portion may be close to a cooling wall surface of the case filled with the heat-dissipating resin. For example, in a situation where the cooling wall surface of the case is a bottom surface of the case, the core is accommodated in the case so that the winding axis of the winding portion of the wire is substantially perpendicular to the bottom surface of the case. In a situation where the cooling wall surface of the case is a side surface of the case, the core is accommodated in the case so that the winding axis of the winding portion of the wire is substantially parallel to the bottom surface of the case.

Preferably, between the first base portion and the one end of the middle leg portion is an air layer having a thickness of 1.9 mm or less. With the air layer between the first base portion and the one end of the middle leg portion, stress (e.g., thermal expansion force) generated at the middle leg portion is more certainly not transferred to the first base portion. Note that, with the thickness of the air layer being not more than the predetermined value, a magnetic circuit is readily formed between the middle leg portion and the first base portion.

The one end of the middle leg portion may be located below the venting surface of the heat-dissipating resin. With such a structure, the heat-dissipation ability of the middle leg portion and the winding portion, disposed around the middle leg portion, of the wire is improved.

The one end of the middle leg portion may be located above the venting surface of the heat-dissipating resin. With such a structure, the air layer having a thickness of 1.9 mm or less is readily provided between the first base portion and the one end of the middle leg portion.

Preferably, the heat-dissipating resin is disposed at a location such that the heat-dissipating resin covers the winding portion disposed around the middle leg portion. With such a structure, the heat-dissipation ability is improved.

An adhesive or the heat-dissipating resin may be at least partly interposed between the other end of the middle leg portion and a surface of the second base portion. Also, the other end of the middle leg portion and the second base portion may be integrally formed.

A tubular portion of a bobbin may be disposed between the middle leg portion and the winding portion of the wire. Alternatively, the winding portion of the wire (e.g., an air core coil) may be disposed around the middle leg portion without the bobbin being disposed.

The coil device may further include a terminal block holding a lead portion of the wire. The terminal block may be attached to the bobbin, the case accommodating the heat-dissipating resin, or the first base portion.

### BRIEF DESCRIPTION OF THE DRAWING(S)

FIG. 1 is a schematic perspective view of a coil device according to an embodiment of the present invention.

FIG. 2 is a schematic exploded perspective view of the coil device shown in FIG. 1.

FIG. 3 is a sectional schematic view along line III-III in FIG. 1 without terminals.

FIG. 4A is a sectional schematic view of a core along line IV-IV shown in FIG. 3.

FIG. 4B is a sectional schematic view of a modified example of the core shown in FIG. 4A.

FIG. 4C is a sectional schematic view of another modified example of the core shown in FIG. 4A.

FIG. 4D is a sectional schematic view of still another modified example of the core shown in FIG. 4A.

FIG. 4E is a sectional schematic view of still another modified example of the core shown in FIG. 4A.

FIG. 5 is a sectional perspective view of a main part of a bobbin shown in FIG. 3.

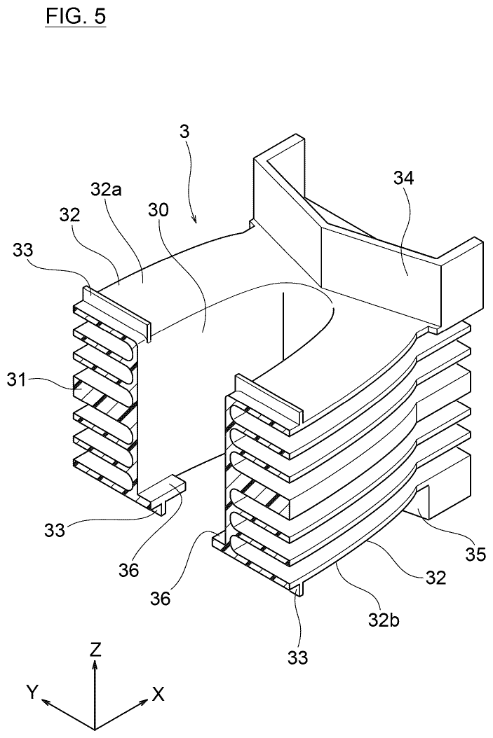

FIG. 6 is a sectional perspective view of a main part of a modified example of the bobbin shown in FIG. 5.

FIG. 7 is a partial exploded perspective view of the bobbin and the core viewed at a different angle, with a part of the core being detached from the bobbin shown in FIG. 2.

### DETAILED DESCRIPTION

Hereinafter, embodiments of the present invention are described with reference to the drawings. Illustrations in the drawings are only schematically and exemplarily provided for understanding of the present invention; and the illustrated appearance, dimensional ratios, etc. may be different from actual ones. The present invention is not limited to the following embodiments.

### First Embodiment

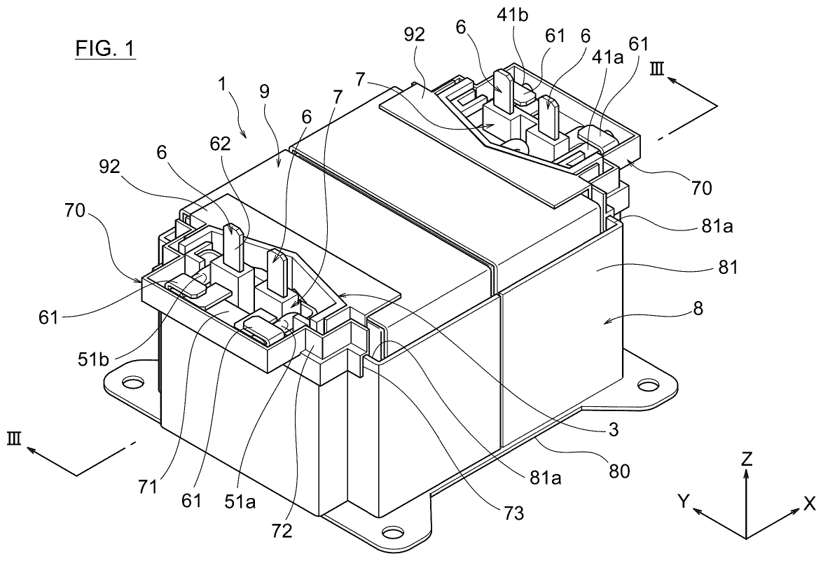

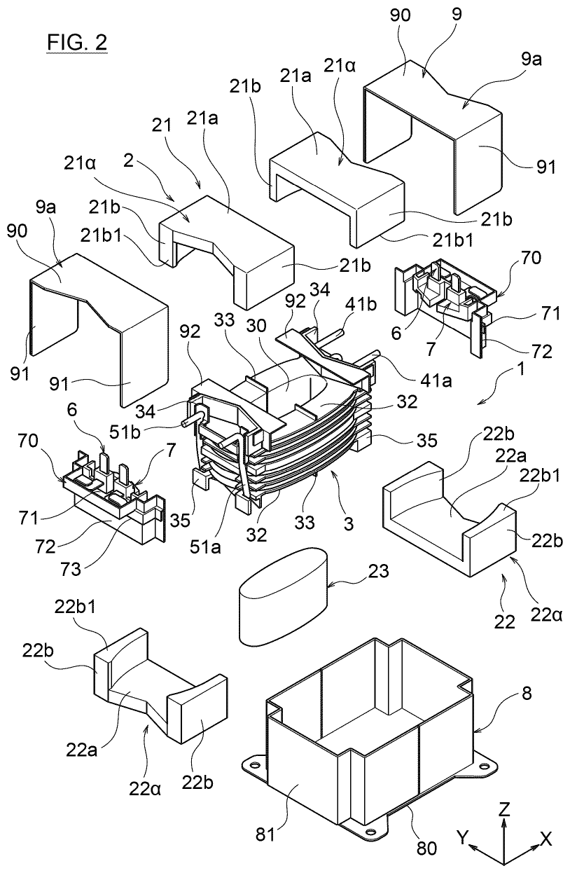

A coil device 1 according to an embodiment of the present invention shown in FIG. 1 functions as, for example, a leakage transformer and is included in an on-board charger, a power supply circuit of various electronic equipment, etc. As shown in FIG. 2, the coil device 1 includes a core 2, a bobbin 3, terminal blocks 7 combined with respective wire connection covers 70, and a case 8. In the drawings, the X-axis, the Y-axis, and the Z-axis are mutually perpendicular; and the Z-axis is parallel to a height direction of the coil device 1 (a winding axis direction of a coil). In the following description, with regard to the X-axis, the Y-axis, and the Z-axis, a direction towards a center of the coil device 1 is referred to as an inward direction, and a direction away from the center of the coil device 1 is referred to as an outward direction.

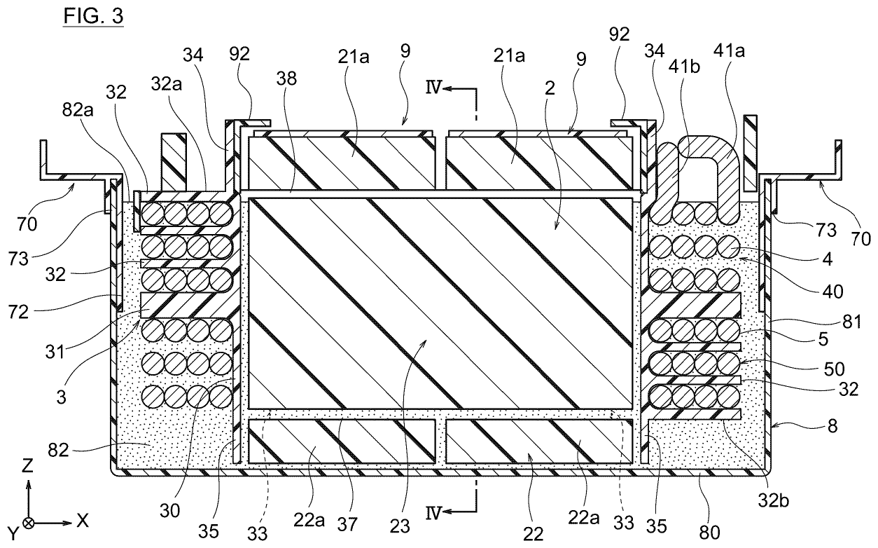

As shown in FIG. 3, a tubular portion 30 of the bobbin 3 is provided with, partway along the Z-axis, a main partitioning flange 31 for insulating a primary side coil against a secondary side coil so that the main partitioning flange 31 protrudes in a radial direction from an outer circumferential surface of the tubular portion 30. The tubular portion 30 is provided with, above the main partitioning flange 31 along the Z-axis, sub-partitioning flanges 32 at predetermined intervals along the Z-axis so that the sub-partitioning flanges 32 protrude in the radial direction from the outer circumferential surface of the tubular portion 30. In a compartment between the main partitioning flange 31 and one of the sub-partitioning flanges 32 and compartments between the sub-partitioning flanges 32, a first wire 4 is wound to form a first wire winding portion 40.

Similarly, the tubular portion 30 is provided with, below the main partitioning flange 31 along the Z-axis, sub-partitioning flanges 32 at predetermined intervals along the Z-axis so that the sub-partitioning flanges 32 protrude in the radial direction from the outer circumferential surface of the tubular portion 30. In a compartment between the main partitioning flange 31 and one of the sub-partitioning flanges 32 and compartments between the sub-partitioning flanges 32, a second wire 5 is wound to form a second wire winding portion 50.

The compartments between the main partitioning flange 31 and the sub-partitioning flanges 32 along the Z-axis and the compartments between the sub-partitioning flanges 32 have a size slightly larger than an external diameter of the first wire 4 or the second wire 5; and only one row of the wire 4 or 5 can enter each of these compartments along the Z-axis. Thus, the wire 4 or 5 can be orderly wound around the outer circumferential surface of the tubular portion 30 of the bobbin 3.

At least at one point of each sub-partitioning flange 32 along its circumferential direction, the sub-partitioning flange 32 has a notch extending in the radial direction from a circumferential point of the sub-partitioning flange 32 to a circumferential point of the tubular portion 30. Via this notch, the wire 4 or 5 can be moved along the Z-axis between the adjacent compartments; and the wire 4 or 5 can be continuously wound around. How the wire 4 or 5 is wound is not limited; and it may be, for example, normally wound or α-wound.

In the present embodiment, the second wire winding portion 50 is disposed below the first wire winding portion 40 along the Z-axis; however, they may be disposed vice versa. In the present embodiment, for example, the first wire winding portion 40 is the primary side coil of the transformer, and the second wire winding portion 50 is the secondary side coil of the transformer; however, they may be vice versa. The first wire winding portion 40 and the second wire winding portion 50 are separated by the main partitioning flange 31 in the Z-axis direction, and their coupling coefficient and the like are adjusted.

In the present embodiment, the first wire 4 and the second wire 5 are each constituted by a conductive wire. It may be that the wire is not insulation coated; however, the wire is preferably insulation coated. The conductive wire may be of any type and may be a conductive core wire (e.g., round wire, rectangular wire, stranded wire, litz wire, or braided wire). A fusing layer or an insulation layer covering the core wire may be made from any material; and examples of such materials include polyurethane, polyamide-imide, polyimide, and polyester.

In the present embodiment, the first wire 4 and the second wire 5 are each constituted by a self-fusing wire; however, either one of the wires may be a self-fusing wire, or both of the wires may be constituted by other wires. At least either the first wire winding portion 40 or the second wire winding portion 50 may be a flat coil. The first wire 4 and the second wire 5 may have the same diameter or different diameters. The diameters are not limited and are preferably, for example, within a range of 1.0 to 3.0 mm.

The first wire 4 constituting the first wire winding portion 40 includes lead portions 41a and 41b at both ends. The respective lead portions 41a and 41b are drawn upwards along the Z-axis from the first wire winding portion 40 and are connected to terminals 6 and 6 shown in FIG. 1. The second wire 5 constituting the second wire winding portion 50 shown in FIG. 3 includes lead portions 51a and 51b shown in FIG. 2 at both ends. The respective lead portions 51a and 51b are drawn upwards along the Z-axis from the second wire winding portion 50 and are connected to terminals 6 and 6.

The respective terminals 6 to which these lead portions 41a, 41b, 51a, and 51b are connected are attached to the terminal blocks 7. To the terminal blocks 7, the respective wire connection covers 70 are attached. With the wire connection covers 70 combined with the terminal blocks 7, each pair of terminals 6 with a predetermined distance therebetween along the Y-axis is fixed to the corresponding terminal block 7. The terminal blocks 7 and the wire connection covers 70 are preferably constituted by an insulating member (e.g., synthetic resin). The terminal blocks 7 and the wire connection covers 70 may be constituted by the same insulating material or different insulating materials.

In the present embodiment, as shown in FIG. 1, the terminal blocks 7 are, together with the wire connection covers 70, attachable to an upper end of a side plate 81 of the case 8. For example, each of the wire connection covers 70 includes a bottom plate piece 71 and a side plate piece 72. The bottom plate piece 71 covers, from below along the Z-axis, respective wire connecting portions 61 of the terminals 6 embedded in the corresponding terminal block 7. The side plate piece 72 is substantially perpendicularly integrated with the bottom plate piece 71 and has an attachment groove 73.

The attachment groove 73 of the side plate piece 72 has a shape fitting the shape of the upper end of the side plate 81 of the case 8 so that the upper end 81a, at both sides in the X-axis direction, of the side plate 81 is inserted in the attachment groove 73. With the upper end, at both sides in the X-axis direction, of the side plate 81 of the case 8 entering the attachment groove 73 of each of the wire connection covers 70, the wire connection covers 70 are attached to the case 8.

Preferably, the terminal blocks 7 are provided separately from the wire connection covers. Connecting the lead portions 41a, 41b, 51a, and 51b to the respective wire connecting portions 61 of the terminals 6 is easier when the wire connection covers are separated from the terminal blocks. To each wire connecting portion 61, the corresponding lead portion 41a, 41b, 51a, or 51b is connected by, for example, crimping, thermocompression bonding, laser welding, or soldering. Preferably, after the lead portions 41a, 41b, 51a, and 51b are connected to the wire connecting portions 61 of the terminals 6, the terminal blocks 7 and the wire connection covers 70 are combined and are attached to the case 8 and/or the bobbin 3.

In the present embodiment, each terminal 6 is preferably insert-molded with the corresponding terminal block 7 so that the wire connecting portion 61 and an external connection portion 62 of the terminal 6 are exposed. The terminal 6 is fixed to the terminal block 7 so that the wire connecting portion 61 protrudes outwards along the X-axis with respect to the terminal block 7 and that the external connection portion 62 protrudes upwards along the Z-axis with respect to the terminal block 7. The external connection portion 62 is a portion connectable to, for example, an external connection terminal or a terminal connection recess of a circuit substrate not shown in the drawings. The terminal 6 including the wire connecting portion 61 and the external connection portion 62 is formed by, for example, stamping one metal plate.

As shown in FIG. 2, in the present embodiment, the core 2 can be divided into a first core 21, a second core 22, and a middle leg portion 23. The first core 21 is disposed above the second core 22 along the Z-axis. The second core 22 is disposed below the first core 21 along the Z-axis. The middle leg portion 23 is disposed between the first core 21 and the second core 22. The first core 21 is divided into two first core divisions 21a along the X-axis. Similarly, the second core 22 is divided into two second core divisions 22a along the X-axis.

Each of the first core divisions 21a includes a first base portion 21a having a flat shape and side leg portions 21b protruding downwards along the Z-axis from both sides of the first base portion 21a in the Y-axis direction. Each of the second core divisions 22a includes a second base portion 22a having a flat shape and side leg portions 22b protruding upwards along the Z-axis from both sides of the second base portion 22a in the Y-axis direction.

In the present embodiment, the first core divisions 21a and the second core divisions 22a are each a U-shaped core having a substantially U-shape in its section parallel to a plane containing the Z-axis and the Y-axis; and the first core divisions 21a and the second core divisions 22a have the same shape but may have different shapes. For example, either of the cores may be a U-shaped core, and the other may be an I-shaped core.

The first base portion 21a of each first core division 21a is attached to an outer surface of the sub-partitioning flange 32 at an upper end of the tubular portion 30 of the bobbin 3 before core holding members 92 are attached to the bobbin 3. Note that the outer surface (upper surface 32a) of the sub-partitioning flange 32 at the upper end of the tubular portion 30 is provided with a positioning projection 33, which can provide a space between the adjacent first base portions 21a and 21a. With such a space, improvement of heat-dissipating ability can be expected.

The second base portion 22a of each second core division 22a is attached to an outer surface of the sub-partitioning flange 32 at a lower end of the tubular portion 30 of the bobbin 3. Note that the outer surface (lower surface 32b) of the sub-partitioning flange 32 at the lower end of the tubular portion 30 is provided with a positioning projection 33, which can provide a space between the adjacent second base portions 22a and 22a. With such a space, improvement of heat-dissipating ability can be expected.

As shown in FIG. 2, core guide walls 34 are provided at both sides in the X-axis direction of the sub-partitioning flange 32 at the upper end of the tubular portion 30 of the bobbin 3 along the Z-axis. Inwards from the core guide walls 34, the core holding members 92 are disposed. Before the core holding members 92 are disposed inwards from the core guide walls 34, the middle leg portion 23 is inserted from above in the Z-axis direction into a through-hole defined by an inner circumferential surface of the tubular portion 30 of the bobbin 3.

Then, against the outer surface (upper surface) of the sub-partitioning flange 32 between the core guide walls 34, the first base portions 21a of the first core divisions 21a of the first core 21 are placed. The side leg portions 21b of the first core 21 cover, along the Z-axis, an upper portion of the bobbin 3 at both sides in the Y-axis direction. Then, inwards from the core guide walls 34, the core holding members 92 are inserted in spaces between the core guide walls 34 and the first core 21.

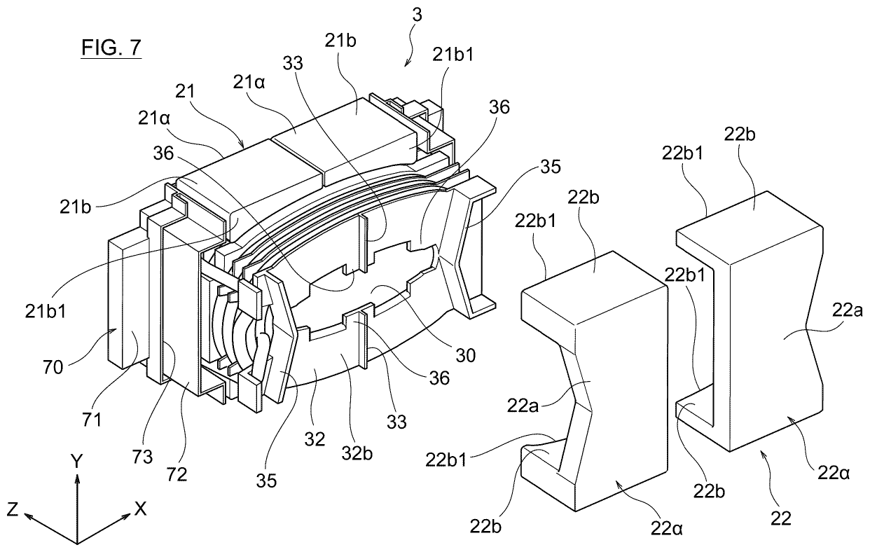

As shown in FIG. 7, core guide walls 35 are provided at both sides in the X-axis direction of the sub-partitioning flange 32 at the lower end of the tubular portion 30 of the bobbin 3 along the Z-axis. Against the outer surface (lower surface) of the sub-partitioning flange 32 between the core guide walls 35, the second base portions 22a of the second core divisions 22a of the second core 22 are placed. The side leg portions 22b of the second core 22 cover, along the Z-axis, a lower portion of the bobbin 3 at both sides in the Y-axis direction. Extremities 22b1 of the side leg portions 22b and extremities 21b1 of the side leg portions 21b of the first core 21 abut each other and, as necessary, are joined using an adhesive.

At an inner circumferential surface of the sub-partitioning flange 32 at the lower end of the tubular portion 30 of the bobbin 3 along the Z-axis, inward protrusions 36 protruding inwards from the inner circumferential surface of the tubular portion 30 are provided at multiple positions along its circumferential direction. The inward protrusions 36 protrude from the inner circumferential surface of the tubular portion 30 to the extent that the inward protrusions 36 do not cover a lower end of the through-hole defined by the inner circumferential surface of the tubular portion 30 along the Z-axis. As shown in FIG. 3, the inward protrusions 36 abut an outer circumferential portion of a lower end of the middle leg portion 23 along the Z-axis. Consequently, a space 37 can be provided between the lower end of the middle leg portion 23 along the Z-axis and the second base portions 22a of the second core 22. A heat-dissipating resin 82 enters the space 37. The distance (thickness) of the space 37 can be adjusted by changing a design thickness of the inward protrusions 36 along the Z-axis.

Controlling the length of the middle leg portion 23 along the Z-axis to be smaller by a predetermined length than the height of the tubular portion 30 along the Z-axis (from the inward protrusions 36 to the upper surface 32a of the uppermost sub-partitioning flange 32) can provide a space 38 between an upper end of the middle leg portion 23 along the Z-axis and the first base portions 21a of the first core 21.

In the present embodiment, the location of a venting surface 82a of the heat-dissipating resin 82 with which the case 8 is filled is determined in relation to the volume and the like of the middle leg portion 23 so that the heat-dissipating resin 82 does not enter at least a part of the space 38 and that the middle leg portion 23 is sufficiently cooled. That is, the location of the venting surface 82a is determined so that 70% or more, preferably 80% or more, more preferably 90% or more, or still more preferably 95% or more of the volume of the middle leg portion 23 is located below the venting surface 82a of the heat-dissipating resin 82 and below lower surfaces of the first base portions 21a along the Z-axis. With such a structure, in the space 38, an air layer where the heat-dissipating resin 82 does not enter is provided.

The location of the venting surface 82a of the heat-dissipating resin 82 is determined so that the second wire winding portion 50 of the second wire 5 is sufficiently immersed in the heat-dissipating resin 82 and that preferably 80% or more, more preferably 95% or more, or substantially 100% or more of the first wire winding portion 40 of the first wire 4 is immersed in the heat-dissipating resin 82. With such a structure, heat generated at the winding portion 40 or 50 of the wire 4 or 5 is cooled by the heat-dissipating resin 82. In the present embodiment, heat transferred from the winding portion 40 or 50 of the wire 4 or 5 or the core 2 to the heat-dissipating resin 82 is dissipated, via the case 8, to a cooling member (e.g., a cooling block having a cooling passage) installed under a lower surface of a bottom plate 80 of the case 8. Note that the venting surface 82a is a solidified liquid surface of the heat-dissipating resin 82 in a fluid state entering the case 8.

In the present embodiment, the cores 21 and 22 and the middle leg portion 23 may be any cores containing a magnetic material and may be constituted by, for example, ferrites, metal magnetic materials, or resin containing a magnetic powder.

As shown in FIG. 1, the case 8 includes the bottom plate 80 having a substantially rectangular shape and the side plate 81 extending upwards along the Z-axis from the four sides of the bottom plate 80 to provide a bottomed accommodation space. The top of the case 8 along the Z-axis is open. The case 8 is preferably made of metal with high thermal conductivity (e.g., aluminum) but may be made of resin.

The heat-dissipating resin 82 is also referred to as a potting resin and is constituted by, for example, silicone resin, urethane resin, or epoxy resin, which remain soft after injection. The potting resin has a modulus of longitudinal elasticity of preferably 0.1 to 100 MPa. In the present embodiment, heat generated at the first wire winding portion 40, the second wire winding portion 50, and the core 2 is efficiently dissipated outside from the bottom of the case 8 via, for example, the heat-dissipating resin 82 and the case 8 to allow increase in cooling efficiency of the coil device 1.

The bobbin 3 (with the wires) having the core 2 shown in FIG. 2 attached may be accommodated in the case 8 after the case 8 is filled with the heat-dissipating resin 82 in advance; or the case 8 may be filled with the heat-dissipating resin 82 after the bobbin 3 (with the wires) having the core 2 attached is accommodated in the case 8.

In the coil device 1 according to the present embodiment, because most of the volume of the middle leg portion 23 of the core 2 is located below the venting surface 82a of the heat-dissipating resin 82 as shown in FIG. 3, most of the volumes of the winding portions 40 and 50, disposed around the middle leg portion 23, of the wires 4 and 5 as well as the middle leg portion 23 is cooled by the heat-dissipating resin 82. This improves heat-dissipating ability. Moreover, because the first base portions 21a are disposed apart by the predetermined distance of the space 38 from one end (the upper end) of the middle leg portion 23 along the Z-axis, stress (e.g., thermal expansion force) generated at the middle leg portion 23 is not transferred to the first base portions 21a even if the first base portions 21a are partly exposed from the heat-dissipating resin 82. Thus, excessive thermal stress that may be generated at the first base portions 21a can be reduced.

Because first base portions 21a at an upper side along the Z-axis and a middle leg portion 23 are typically integrated in a conventional core 2 accommodated in a case 8, an increase in temperature difference between the first base portions 21a and the middle leg portion 23 causes concentration of stress particularly at the first base portions, possibly causing trouble (e.g., cracks or chips of the core).

In the present embodiment, even if the temperature difference between the first base portions 21a and the middle leg portion 23 increases, it is difficult for stress to be concentrated at the first base portions due to the space having the air layer between the first base portions 21a and the middle leg portion 23. Consequently, possibility of trouble (e.g., cracks or chips of the core) can be reduced. According to an experiment by the present inventors and the like, it is confirmed that back maximum stress generated at the first base portions of the core of the present embodiment is reduced by approximately 25% or more from back maximum stress generated at the first base portions of the conventional core.

In the present embodiment, 30% or more, 50% or more, 80% or more, 95% or more, or preferably 100% or more of the volume of the first base portions 21a is exposed from the heat-dissipating resin 82. With most of the first base portions 21a being exposed, the case 8 accommodating the heat-dissipating resin 82 can be reduced in size, and the amount of the heat-dissipating resin 82 can be reduced. Moreover, in this situation as well, because the first base portions 21a are disposed apart by the predetermined distance of the space 38 from the upper end of the middle leg portion 23 along the Z-axis, stress (e.g., thermal expansion force) generated at the middle leg portion 23 where heat is readily built up is not transferred to the first base portions 21a. Thus, excessive thermal stress that may be generated at the first base portions 21a can be reduced.

The core 2 may further include a second base portion 22a that is continuously formed at the other end (lower end) of the middle leg portion 23 along the Z-axis; however, the core 2 of the present embodiment further includes the second base portions 22a disposed apart by the predetermined distance of the space 37 from the lower end of the middle leg portion 23 along the Z-axis.

The second base portions 22a are close to the bottom plate 80, which is a cooling wall surface of the case 8 filled with the heat-dissipating resin 82. In the present embodiment, because the cooling wall surface of the case 8 is a bottom surface of the case 8, the core 2 is accommodated in the case 8 so that the winding axes of the winding portions 40 and 50 of the wires 4 and 5 are substantially perpendicular to the bottom surface of the case 8. In a situation where the cooling wall surface of the case 8 is a side surface (side plate 81) of the case 8 in another embodiment, the core 2 may be accommodated in the case 8 so that the winding axes of the winding portions 40 and 50 of the wires 4 and 5 are substantially parallel to the bottom surface of the case 8.

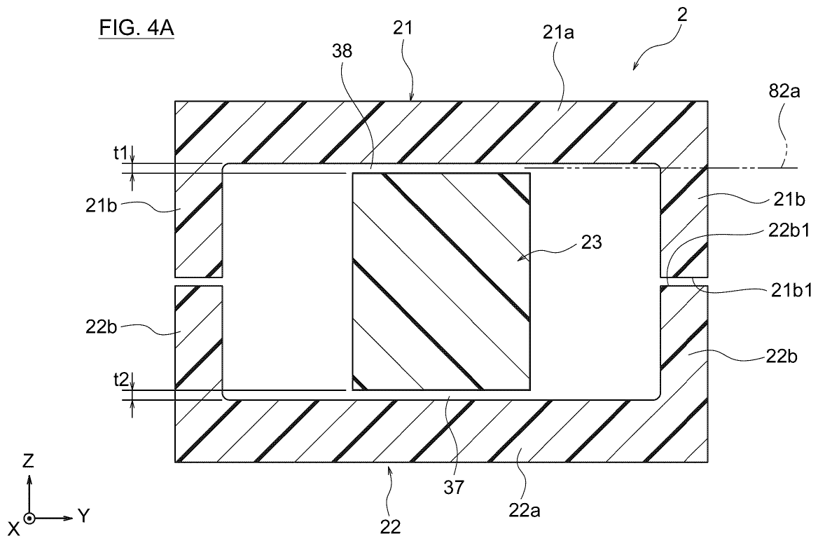

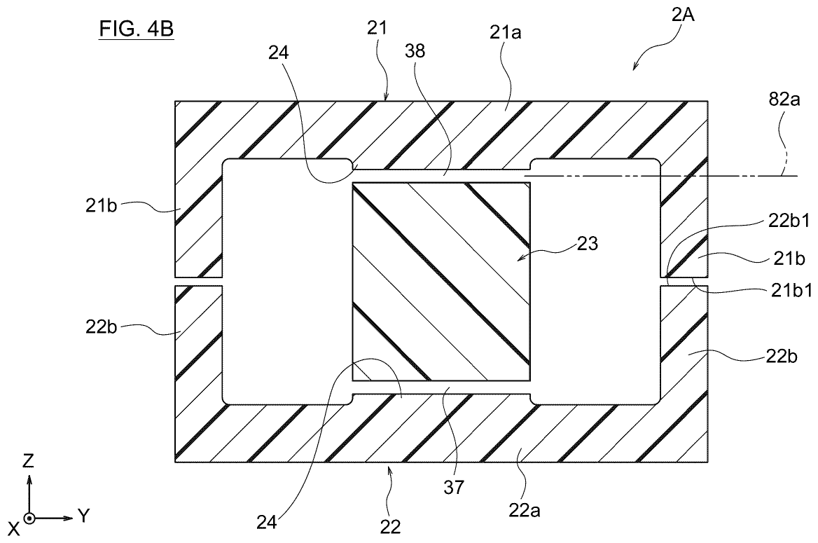

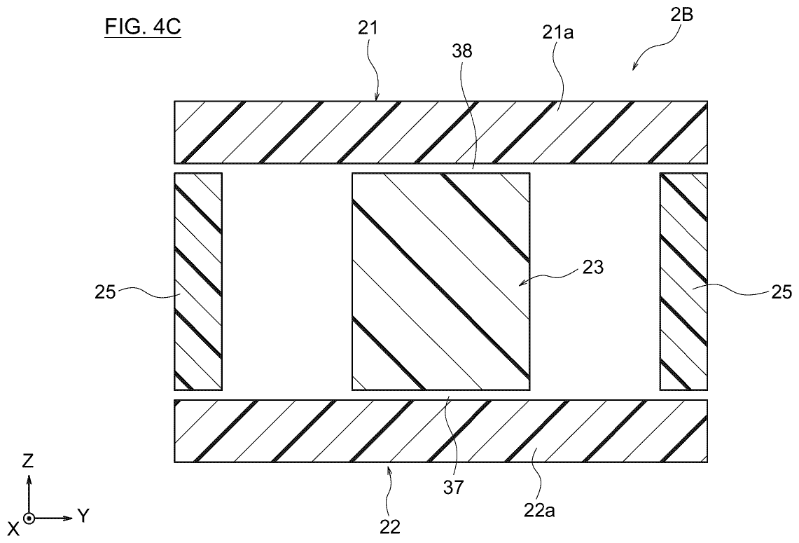

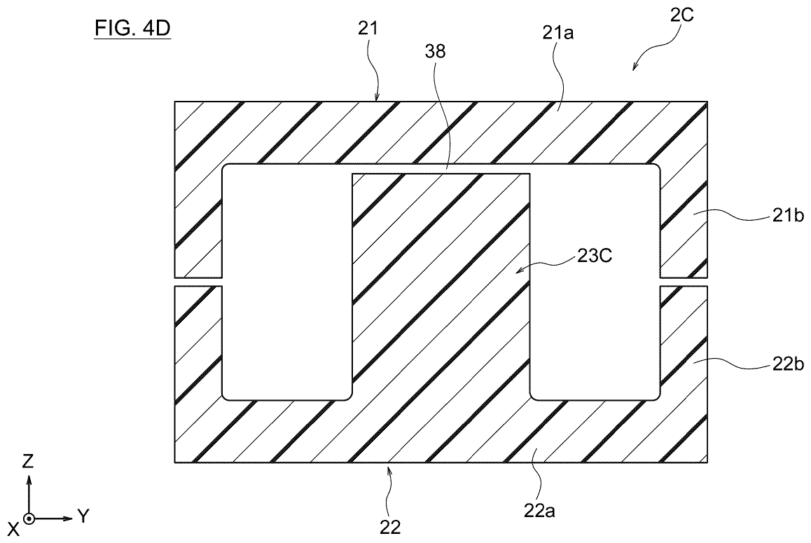

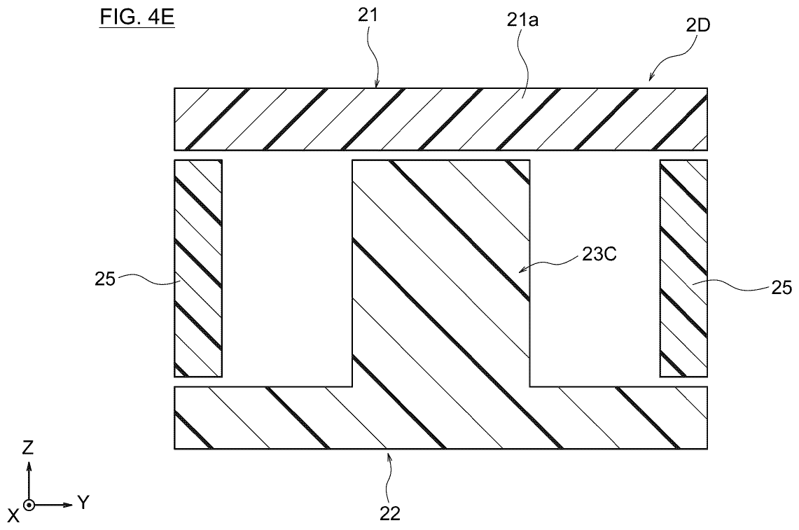

In the present embodiment, the air layer having a thickness of 1.9 mm or less is provided in the space 38 between the first base portions 21a and the upper end of the middle leg portion 23. With the air layer where the heat-dissipating resin 82 does not enter being present in the space 38, stress (e.g., thermal expansion force) generated at the middle leg portion 23 is more certainly not transferred to the first base portions 21a. Note that, with the distance (thickness) of the air layer of the space 38 being not more than the predetermined value, a magnetic circuit is readily formed between the middle leg portion 23 and the first base portions 21a. As shown in FIG. 4A, a thickness t1 of the space 38 along the Z-axis and a thickness t2 of the space 37 along the Z-axis may be the same or different; however, t1 and t2 are preferably 3 mm or less, 2 mm or less, or 1.9 mm or less.

In the present embodiment, the upper end of the middle leg portion 23 may be located below the venting surface 82a of the heat-dissipating resin 82 along the Z-axis. With such a structure, heat-dissipation ability of the middle leg portion and the winding portions of the wires disposed therearound is improved. In this situation as well, the venting surface 82a is preferably located partway in the space 38 so that the space 38 has the air layer.

Alternatively, the upper end of the middle leg portion 23 may be located above the venting surface 82a of the heat-dissipating resin 82. With such a structure, the space 38 readily has the air layer having a thickness of 1.9 mm or less.

In the present embodiment, the venting surface 82a of the heat-dissipating resin 82 is located at a location such that the heat-dissipating resin 82 covers the winding portions 40 and 50, disposed around the middle leg portion 23, of the wires 4 and 5. With such a structure, heat-dissipation ability is further improved.

In the present embodiment, an adhesive or the heat-dissipating resin 82 may be at least partly interposed between the lower end of the middle leg portion 23 along the Z-axis and respective surfaces of the second base portions 22a. Alternatively, the lower end of the middle leg portion 23 and the second base portions 22a may be integrated.

In the present embodiment, the tubular portion 30 of the bobbin 3 is disposed between the middle leg portion 23 and the winding portions 40 and 50 of the wires 4 and 5; however, the winding portions 40 and 50 (e.g., air core coils) of the wires 4 and 5 may be disposed around the middle leg portion 23 without the bobbin 3 being disposed.

In the present embodiment, the coil device 1 further includes the terminal blocks 7 holding the lead portions 41a, 41b, 51a, and 51b of the wires 4 and 5; and the terminal blocks 7 are attached to the bobbin 3 or the case 8; however, the terminal blocks 7 may be directly fixed or attached to the first base portions 21a of the core 2.

### Second Embodiment

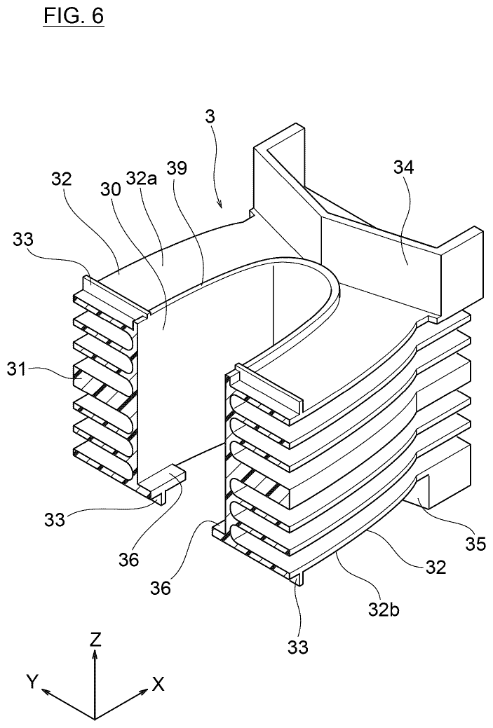

As shown in FIG. 6, a coil device of the present embodiment is similar to the coil device 1 of the aforementioned embodiment unless otherwise described below and exhibits similar effects. That is, in the present embodiment, a protruding frame 39 continuing from an inner circumferential surface of a tubular portion 30 is provided around a through-hole so as to protrude from a surface of an uppermost sub-partitioning flange 32 of a bobbin 3 along the Z-axis. A top surface of the protruding frame 39 protrudes into, for example, inner surfaces of first base portions 21a shown in FIG. 3. Thus, the protruding length of the protruding frame 39 is one factor in adjusting the distance (thickness) of a space 38 along the Z-axis.

The protruding frame 39 makes it difficult for a heat-dissipating resin 82 to enter the space 38 from around the protruding frame 39 even if a venting surface 82a of the heat-dissipating resin 82 is higher than an upper surface 32a of the sub-partitioning flange 32, making the space readily have an air layer. Other structures and effects are similar to those of the aforementioned embodiment, and description of the similarities is omitted.

### Third Embodiment

As shown in FIG. 4B, a coil device of the present embodiment is similar to the coil device of the first or second embodiment unless otherwise described below and exhibits similar effects. That is, the coil device of the present embodiment has a similar structure except that the coil device includes a core 2A different from the core 2 of the aforementioned embodiments and exhibits similar effects.

The core 2A of the present embodiment is different from the core 2 of the aforementioned embodiments in that the core 2A includes step-like protruding portions 24 at respective inner surfaces of first base portions 21a facing an upper end or a lower end of a middle leg portion 23 along the Z-axis. The step-like protruding portions 24 may have any protruding length (along the Z-axis) so long as a space 38 or 37 is provided between extremities of the step-like protruding portions 24 along the Z-axis and the upper or lower end of the middle leg portion 23.

However, it is desirable that the protruding length of the step-like protruding portions 24 facing the upper end of the middle leg portion 23 be as small as possible. To provide the space 38 with an air layer, a venting surface 82a of a heat-dissipating resin is located preferably partway in the space 38 along the Z-axis; and the protruding length of the step-like protruding portions 24 is preferably adjusted so that the venting surface 82a is not too low. Other structures and effects are similar to those of the aforementioned embodiments, and description of the similarities is omitted.

### Fourth Embodiment

As shown in FIG. 4C, a coil device of the present embodiment is similar to the coil devices of the first to third embodiments unless otherwise described below and exhibits similar effects. That is, the coil device of the present embodiment has a similar structure except that the coil device includes a core 2B different from the core 2 or the core 2A of the aforementioned embodiments and exhibits similar effects.

The core 2B of the present embodiment is different from the core 2 of the aforementioned embodiments in that a first core 21 includes first base portions 21a independent from side leg portions 25 and that a second core 22 includes second base portions 22a independent from the side leg portions 25. The side leg portions 25 have a structure in which the corresponding side leg portions 21b and 22b, which face each other along the Z-axis direction, of the aforementioned embodiments are integrated and are separated from the respective base portions 21a and 22a. Other structures and effects are similar to those of the aforementioned embodiments, and description of the similarities is omitted.

### Fifth Embodiment

As shown in FIG. 4D, a coil device of the present embodiment is similar to the coil devices of the first to fourth embodiments unless otherwise described below and exhibits similar effects. That is, the coil device of the present embodiment has a similar structure except that the coil device includes a core 2C different from the core 2, 2A, or 2B of the aforementioned embodiments and exhibits similar effects.

The core 2C of the present embodiment is different from the core 2 of the aforementioned embodiments in that a lower end of a middle leg portion 23C is integrated with a second base portion 22a of a second core 22. Other structures and effects are similar to those of the aforementioned embodiments, and description of the similarities is omitted.

### Sixth Embodiment

As shown in FIG. 4E, a coil device of the present embodiment is similar to the coil devices of the first to fifth embodiments unless otherwise described below and exhibits similar effects. That is, the coil device of the present embodiment has a similar structure except that the coil device includes a core 2D different from the core 2, 2A, 2B, or 2C of the aforementioned embodiments and exhibits similar effects.

The core 2D of the present embodiment is different from the core 2B of the aforementioned embodiment shown in FIG. 4C in that a lower end of a middle leg portion 23C is integrated with a second base portion 22a of a second core 22. Other structures and effects are similar to those of the aforementioned embodiments, and description of the similarities is omitted.

The present invention is not limited to the above embodiments and can variously be modified within the scope of the present invention.

For example, while the core 2 includes a combination of five or seven divisions of the core in the above embodiments, the number of divisions is not limited to these; and the core can include a combination of, for example, two divisions, three divisions, four divisions, or other number of divisions.

As described above, it may be that there is no bobbin 3; and air core coils constituted by the first wire winding portion 40 and the second wire winding portion 50 may be disposed around the middle leg portion 23, without the bobbin 3 interposed therebetween.

In a situation where there is no tubular portion 30 of the bobbin 3 and the winding portion 40 or 50 of a wire is directly disposed around the middle leg portion 23 of the core 2, the first wire 4 and the second wire 5 are preferably constituted by self-fusing conductive wires each including a fusing layer and an insulating layer. Also, the first wire winding portion 40 where the first wire 4 is wound and the second wire winding portion 50 where the second wire 5 is wound are preferably formed in a coil shape in advance and are preferably provided, for example, in a form of air core coils.

The terminal blocks 7 provided with the wire connection covers 70 may be attached to the case 8; however, they may be directly attached to the first base portions 21a of the core 2 at an upper side along the Z-axis. Note that means for directly fixing the terminal blocks 7 to the core 2 are not limited, and examples of such means include adhesives, fusion, taping, and any other fixing means other than fixing using the bobbin.

In the above embodiments, as shown in FIG. 2 or the like, heat-dissipating plate divisions 9a of a heat-dissipating plate 9 are disposed so as to cover the first base portions 21a and the side leg portions 21b and 22b of the core 2; however, the structure of the heat-dissipating plate 9 is not limited to the example illustrated in the drawings. For example, while the heat-dissipating plate divisions 9a of the heat-dissipating plate 9 shown in FIG. 2 each include a top plate portion 90 and side plate portions 91, the heat-dissipating plate divisions 9a may be continuously provided. Alternatively, it may be that no heat-dissipating plate 9 is disposed.

### REFERENCE NUMERALS

1 . . . coil device
2, 2A to 2D . . . core
21 . . . first core
21a . . . first core division
21a . . . first base portion
21b . . . side leg portion
21b1 . . . extremity
22 . . . second core
22a . . . second core division
22a . . . second base portion
22b . . . side leg portion
22b1 . . . extremity
23, 23C . . . middle leg portion
24 . . . step-like protruding portion
25 . . . side leg portion
3 . . . bobbin
30 . . . tubular portion
31 . . . main partitioning flange
32 . . . sub-partitioning flange
32a . . . upper surface
32b . . . lower surface
33 . . . positioning projection
34, 35 . . . core guide wall
36 . . . inward protrusion
37, 38 . . . space
39 . . . protruding frame
4 . . . first wire
40 . . . first wire winding portion
41a, 41b . . . lead portion
5 . . . second wire
50 . . . second wire winding portion
51a, 51b . . . lead portion
6 . . . terminal
61 . . . wire connecting portion
62 . . . external connection portion
7 . . . terminal block
70 . . . wire connection cover
71 . . . bottom plate piece
72 . . . side plate piece
73 . . . attachment groove
8 . . . case
80 . . . bottom plate
81 . . . side plate
81a . . . upper end
82 . . . heat-dissipating resin
82a . . . venting surface
9 . . . heat-dissipating plate
9a . . . heat-dissipating plate division
90 . . . top plate portion
91 . . . side plate portion
92 . . . core holding member

What is claimed is:

1. A coil device comprising:
a core comprising a magnetic material; and
a wire disposed in a coil shape around at least a part of the core,
wherein
the core comprises a middle leg portion and a first base portion;
the middle leg portion has a winding portion of the wire disposed therearound;
the first base portion is disposed apart by a predetermined distance from one end of the middle leg portion along a winding axis of the winding portion; and
70% or more of a volume of the middle leg portion is located below a venting surface of a heat-dissipating resin.

2. The coil device according to claim 1, wherein 30% or more of a volume of the first base portion is exposed from the heat-dissipating resin.

3. The coil device according to claim 1, wherein the core further comprises a second base portion provided continuously at an other end of the middle leg portion along the winding axis.

4. The coil device according to claim 1, wherein the core further comprises a second base portion disposed apart by a predetermined distance from an other end of the middle leg portion along the winding axis.

5. The coil device according to claim 3, wherein the second base portion is close to a cooling wall surface of a case filled with the heat-dissipating resin.

6. The coil device according to claim 1, wherein between the first base portion and the one end of the middle leg portion is an air layer having a thickness of 1.9 mm or less.

7. The coil device according to claim 6, wherein the one end of the middle leg portion is located below the venting surface of the heat-dissipating resin.

8. The coil device according to claim 6, wherein the one end of the middle leg portion is located above the venting surface of the heat-dissipating resin.

9. The coil device according to claim 7, wherein the heat-dissipating resin is disposed at a location such that the heat-dissipating resin covers the winding portion disposed around the middle leg portion.

10. The coil device according to claim 4, wherein an adhesive or the heat-dissipating resin is at least partly interposed between the other end of the middle leg portion and a surface of the second base portion.

11. The coil device according to claim 1, wherein a tubular portion of a bobbin is disposed between the middle leg portion and the winding portion of the wire.

12. The coil device according to claim 1, further comprising a terminal block holding a lead portion of the wire.

13. The coil device according to claim 12, wherein the terminal block is attached to a bobbin, a case accommodating the heat-dissipating resin, or the first base portion.
